(19) United States
(12) Patent Application Publication
(10) Pub. No.: US 2008/0059327 A1
(43) Pub. Date: Mar. 6, 2008

(54) METHODS & SYSTEMS FOR ELECTRONIC COMMERCE FACILITY CLIENT-BASED PRESENTATION OFFER MANAGEMENT

(76) Inventor: Mark C. Bloomfield, Ponte Vedra, FL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/843,864

(22) Filed: Aug. 23, 2007

Related U.S. Application Data
(60) Provisional application No. 60/842,257, filed on Sep. 5, 2006.
(60) Provisional application No. 60/866,716, filed on Nov. 21, 2006.
(60) Provisional application No. 60/956,502, filed on Aug. 17, 2007.

(51) Int. Cl. G06Q 30/00; G06Q 40/00

(52) U.S. Cl. 705/26

(57) ABSTRACT

A method, system and computer readable medium for facilitating interactive electronic commerce transactions over an electronic commerce network between a seller and a plurality of buyers. A request is received from a seller to generate an auction program associated with the seller over the electronic commerce. An auction program associated with the seller is generated by an electronic commerce computer. A Uniform Resource Locator (URL) hyperlink associated with the auction program is generated by the electronic commerce computer. The URL hyperlink is forwarded to the seller for inclusion into a web page hosted on a website that displays information associated with an item for sale.

### CROSS-REFERENCE TO RELATED APPLICATIONS

The present patent application is a formalization of previously filed, co-pending provisional patent applications: “Network Based Electronic Commerce Facility Client-Based Presentation Offer Management Methods and Systems,” filed on Sep. 5, 2006 as U.S. patent application Ser. No. 60/842,257; “Methods and Systems for Electronic Commerce Facility Client-Based Presentation Offer Management,” filed on Nov. 21, 2006 as U.S. patent application Ser. No. 60/866,716; and “Methods and Systems for Electronic Commerce Facility Client-Based Presentation Offer Management,” filed on Aug. 17, 2007 as U.S. patent application Ser. No. 60/956,502; each by the inventor named in this patent application. This patent application claims the benefit of the filing date of each cited provisional patent application according to the statutes and rules governing provisional patent applications. The specification and drawings of each provisional patent application are specifically incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to network-based electronic commerce and, in particular, to the buying and selling of goods and services on the Internet and the methods and systems used to facilitate electronic commerce.

### BACKGROUND OF THE INVENTION

The Internet has been utilized for many years to provide the backbone necessary to facilitate and host communications and services by electronic commerce (herein referred to as ecommerce) companies who specialize in creating and managing virtual marketplaces for buyers and sellers to conduct business. Many ecommerce companies, such as eBay, have become market makers in that they not only provide the platform and tools necessary to conduct an online business, but they also provide the market presence to attract many customers. With the proliferation and increasing volume of online businesses on the Internet, it has also become increasingly more difficult to establish a market presence without considerable costs.

Companies such as eBay, have successfully reached the critical mass necessary to be pervasive in the ecommerce industry. It is estimated that there are over 1000 companies similar to eBay who compete by offering a variety of auction-styled ecommerce environments that address a wide range of horizontal and vertical marketplaces. Historically, sellers want to conduct business where there are many buyers and buyers want to conduct business where there are many choices. As the online auction industry has matured, the mass market approach for many sellers has been an effort with diminishing returns as the principal differentiation for buyers has become price.

The primary components of facilitating an online auction are the identification of the seller, the presentation of the product or service to be sold, and a means for conducting the auction. If one of the three components is missing, a buyer cannot complete a sale.

Prior art for online auctions in the field of the invention are directed to one of the two methods for conducting online auctions.

In the first example of prior art, a method is taught by companies who provide third party auction services such as eBay. These providers provide use of their comprehensive auction platforms and ecommerce solutions for sellers and buyers to conduct business. The elements that are common to this method of online auctions are that the seller must first create a seller account with the provider and then list the product or service to be sold on the provider's ecommerce platform. Listing is accomplished through a combination of the seller uploading photographs and/or inputting descriptive information about the product to be sold on the provider's platform such that a prospective buyer will be sufficiently informed as to the product being auctioned by the seller. Therefore, a direct association is created between the seller and the product to be sold by this means of account creation and listing on the platform. Buyers are then directed to the service provider's ecommerce platform and to the product and thus the seller. If the seller does not list a product for sale on the ecommerce platform, then no business can be conducted using this method even though a seller account has been created.

Under the service provider auction scenario, all three components are provided by the service provider platform by virtue of the seller creating an user account (identification), uploading photos and/or information about the products to be sold into the service provider database (presentation), and utilizing the auction processes of the service provider platform (conducting means). In the second example of prior art, a method is taught by companies who provide software programs that are hosted on either the seller's web site or a third party website for conducting online auctions such as A4auction (http://www.a4auction.com). These companies, of which there are hundreds, provide either a partial or a turnkey software solution to sellers who desire to host their own auction platform. This method involves the seller purchasing or leasing auction software technology, constructing an auction platform, and then operating the service in a private forum specific to the seller. In this method, the seller account is created by being the provider of the auction. The seller products are listed by uploading photographs and/or inputting descriptive information about the product to be sold on the seller's platform such that a prospective buyer will be sufficiently informed as to the product being auctioned by the seller. Buyers are then directed to the seller's ecommerce platform and to a product. A direct association is created between the seller and the product to be sold by the seller being the host of the platform and listing their products on the site. Any product listed on the auction platform will be associated with that seller.

Under the software program scenario, all three components are provided by virtue of the seller hosting and/or owning the auction platform (identification), uploading photos and/or information about the products to be sold into the seller platform database (presentation), and utilizing the auction processes of the seller platform (conducting means).

There are a number of variations to the above mentioned prior art solutions readily available to sellers to enhance their selling experience including software tools and applications to extract or import product information directly from the seller's computer database and/or hosted websites. Additionally there are Uniform Resource Locator (URL) links associated with products and services appearing on a wide variety of seller websites that are linked back to a third party's ecommerce platform. Irrespective of the tools or applications provided, these prior art solutions do not change the fundamental way a seller is required to conduct business in these existing auction solutions.

Therefore, the prior art as it relates to the field of the instant invention includes solutions provided by service companies such as eBay who provide turnkey auction services on a third-party platform on the behalf of sellers to list their products for sale and product companies such as A4auction.com, who provide software programs directly to the seller to operate their own auction platform to list their products for auction.

There exist a number of problems and challenges for sellers not addressed by third party service companies and their methods. Sellers spend a considerable amount of money attempting to differentiate themselves from their competition, through service, reputation, selection, location, and price. Conducting business on a third party site may expose the seller's products and services to buyers but it also exposes the seller's prospects and customers to competing products, services and companies. This is especially disconcerting if the seller's prospect or customer started a search on the seller's web site but because of linkage to the third party auction site, ended up conducting business with a competing company who is also providing products or services on the same site. Auction service companies have attempted to address this problem by segmenting a seller's products from competitors by utilizing storefronts where only the seller's products are being presented to the buyer but are still being hosted on the service provider's platform. These solutions are primarily targeted to merchants who have a sufficient number of products to sell on an ongoing basis to support the cost and operations of managing an online auction store and are not conducive for one off, infrequent, or ad hoc sales.

Software companies who provide auction software to sellers typically provide the seller more control, customization, and customer retention. The problems associated with a seller operated solution are the costs, complexity and commitment required to operate a private auction platform and is not a conducive solution to one off, infrequent, or ad hoc sales.

In addition to the above problems, sellers have spent considerable time and money to develop web sites that are best suited for showcasing their specific products and services. As an example, it is typical for real estate companies to provide comprehensive information on their websites about homes for sale including background information, virtual tours, neighborhood information, tax information, market information, blogs, and the like, all for the purpose of gaining customers. For a real estate agent to take advantage of a service like eBay, they must abandon their own website presentation of a listing and recreate the listing as much as possible on eBay's site, including retyping descriptions, uploading photographs, and the like. Not only is this effort duplicative, but as mentioned previously, it sends a prospect away from the agent's comprehensive site to a public site where the buyer will be exposed to competitive offerings. The agent could buy software programs and operate their own private auction site to avoid this problem but this method is both costly and complex and further would require the agent to completely reconstruct their web site, even if there was only one listing to auction.

### SUMMARY OF THE INVENTION

Embodiments of the invention provide methods and systems for managing an electronic commerce environment that reduces the costs and complexity of prior art solutions, while providing optimum seller control, product presentation, and prospect retention. In the prior art solutions, all of the functions required to complete an online auction are provided in total by either the service provider or by the end-user software programs.

In embodiments of the instant invention, the three components required for an online auction are provided in the following manner. The seller requests an auction program from a service provider by submitting name and contact information (identification), installs the forwarded auction program link provided by the service provider into the seller's existing website associated with the product for sale (presentation), and utilizes the auction program linked to the service provider to process the auction (conducting means).

In embodiments of the instant invention, content, including pictures and information about the product for sale, is provided to prospective buyers through the existing seller's web site and not a third-party ecommerce site. Some of the benefits to the seller include utilizing the seller's existing website to conduct the auction, eliminating any requirement to duplicate the presentation component elsewhere, and retaining a prospective buyer by not sending the buyer to a third party site to conduct the auction or be exposed to competitive offerings.

In one aspect of the invention, a method, system, and computer readable medium are provided for facilitating interactive electronic commerce transactions over an electronic commerce network between a seller and a plurality of buyers. In the method, a request is received from the seller to generate an auction program associated with the seller over the electronic commerce network. The auction program associated with the seller is generated by an electronic commerce computer. A Uniform Resource Locator (URL) hyperlink associated with the auction program is generated by the electronic commerce computer. The URL hyperlink is forwarded to the seller for inclusion into a web page hosted on a website that displays information associated with an item for sale. The system includes components operating on a processor for executing the steps of the method. The computer readable medium contains program instructions that enable the steps of the method when executed on a computer system.

### BRIEF DESCRIPTION OF DRAWINGS

These and other advantages and aspects of the present invention will become apparent and more readily appreciated from the following detailed description of the invention taken in conjunction with the accompanying drawings, as follows.

FIG. 1 is a network diagram depicting a system having a client-server architecture according to an exemplary embodiment of the invention.

FIG. 2 is a block diagram illustrating a general programmable processing system in accordance with the various embodiments of the present invention.

FIG. 3 illustrates the processing logic for generating and publishing a unique URL for an item being sold on a merchant's web site in an exemplary embodiment of the invention.

FIG. 4A illustrates exemplary processing logic for the merchant (seller) web site offer presentation and acceptance that occurs after the seller activates the item listing in the ecommerce network of the service provider by publishing the web page containing the unique URL link.

FIG. 4B illustrates exemplary processing logic for ranking offers containing conditional terms.

FIG. 5 is a continuation of the process flow diagram of FIG. 4A.

FIG. 6 illustrates exemplary processing logic for returning an item listing to an active status after the winning buyer rejects the offer or fails to respond before the timer clock expires.

FIG. 7 illustrates exemplary processing logic for reactivating or terminating a listing by the seller after the pending sale fails to close with the winning buyer.

FIG. 8 illustrates a seller's web page user interface in accordance with an exemplary embodiment of the invention.

FIG. 9 illustrates an exemplary web page that contains information as to the current offer activity of the associated item as well as a means for the prospective buyer to register a competing offer.

FIG. 10 illustrates an exemplary user interface for enabling a prospective buyer to enter offer information including any contingency information.

FIG. 11 illustrates an exemplary web page that contains information regarding the prospective buyer's offer information relative to other offers for the item.

FIG. 12 illustrates an exemplary user interface for the prospective buyer to register as a new buyer.

FIG. 13 illustrates an exemplary user interface summarizing the prospective buyer's registration information and offer to be submitted for the item.

FIGS. 14-17 illustrate a series of exemplary user interfaces for registering a seller and an item for sale and providing a unique URL to the seller.

FIGS. 18-21 illustrate a series of exemplary notifications to the active buyers regarding the online sale in progress.

FIG. 22 illustrates exemplary processing logic for an exemplary embodiment of the invention.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

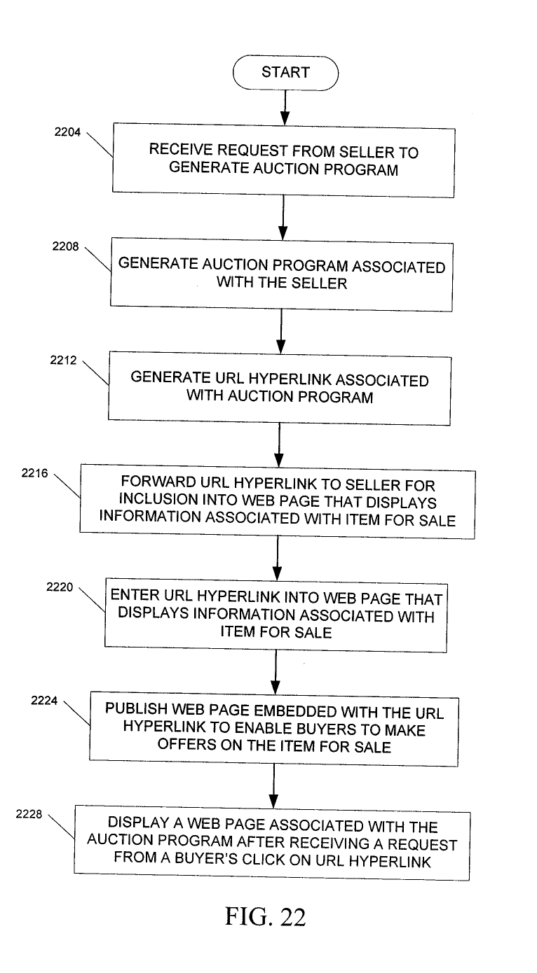

The various embodiments of the present invention described herein are directed to network-based electronic commerce facility offer management methods and systems. FIG. 22 will be described first since it illustrates a series of inventive steps that the appended claims are directed to.

As illustrated in logic block 2204, the method for facilitating interactive electronic commerce transactions begins with an electronic commerce computer receiving a request from a seller to generate an auction program. This request is sent over an electronic commerce network. The term seller can include an agent or a representative of the seller. As indicated in logic block 2208, the electronic commerce computer generates an auction program that is associated with the seller. The auction program can include the seller's identification and contact information that was provided with the request. The auction program generated by the electronic commerce computer can include one or more conditions of sale that are specified by the seller. The electronic computer then generates a URL hyperlink associated with the auction program as indicated in logic block 2212. The hyperlink can include a code segment in the form of computer program instructions that are executed to display auction information on the web page and to communicate auction information over the electronic commerce network. The URL hyperlink can also include information in textual or image form, such as description and images of an item for sale. Forms can be included in the hyperlink that can be completed by a prospective buyer in order to submit an offer on the item for sale. The electronic commerce computer then forwards the URL hyperlink to the seller for inclusion into a web page posted on a website that displays information associated with the item for sale. This step is indicated in logic block 2216. Upon receiving the URL hyperlink from the electronic commerce computer, the seller enters the URL hyperlink into a web page that displays information associated with the item for sale, as indicated in logic block 2220. The seller then publishes the web page embedded with the URL hyperlink to enable buyers to make offers on the item for sale. This step is indicated in logic block 2224. A web page associated with the auction program is displayed after receiving a request from a buyer via a click on the URL hyperlink that is embedded in the web page as indicated in logic block 2228.

Embodiments of the invention described below provide methods and systems for conducting auctions containing conditional terms specific to a seller that effect the overall value of a buyer's offer. For example in the real estate market, conditional terms could include closing terms, contingencies, or financing terms. Buyers can be ranked according to the overall value of their offers utilizing a weighted algorithmic process that combines the offer price with the weighted values associated with the conditional terms of sale as compared to the seller's conditional preferences and competing offers from other buyers. The buyer ranking can be displayed on the seller's website associated with the listing as a means to encourage higher valued offers from existing and new prospective buyers.

In one embodiment of the invention, offer data can be broadcast via email or other electronic means among a community of interested parties to promote and encourage additional competing offers thus furthering the establishment of true market value for the product or service offered for sale.

In one embodiment of the invention described below, a method and system are provided for facilitating interactive electronic commerce transactions over an electronic commerce network between a seller and a plurality of buyers, including information regarding conditional offers. An online listing registration application to generate a seller specific auction is received by an ecommerce computer from a seller via the seller's computer over the electronic commerce network including information associated with the seller. A plurality of sale condition options, in addition to price, is presented for selection by the seller on the registration application. At least one completed condition option is received from the seller in response to the options presented. The listing registration application information and condition selection information received from the seller are stored and processed by an electronic commerce computer. The ecommerce computer generates a unique auction program associated with the requesting seller and seller information. A hyperlink associated with the auction program and with the seller's listing registration, including sale conditions, are generated by the electronic commerce computer and is provided to the seller and/or seller's agent. The hyperlink is incorporated into a web page hosted on a web site featuring the product listing associated with the hyperlink. The web page incorporating the listing hyperlink is then published on the world-wide-web thereby activating the listing on the electronic commerce network. A buyer clicking on the hyperlink will open an interactive presentation window displaying the current offers made on the associated listing and ranking order of the offers. Buyers may view offers, make a trial offer, place a new offer, or modify an existing offer initiated from this window.

In another embodiment of the invention described below, a method and system are provided for facilitating interactive electronic commerce transactions over an electronic commerce network between a seller and a plurality of buyers. An offer is received through an interactive web page displayed within the seller's web page from a prospective buyer for an item for sale. The offer information is displayed to a seller and/or seller's agent associated with the item for sale. A request is received to an ecommerce computer from the seller to broadcast the offer information by electronic mail to at least one other buyer while the offer is pending. The offer information is then broadcast to at least one other buyer under direction of an ecommerce computer in communication with an email server connected to the email network.

In yet another embodiment of the invention described below, a method and system are provided for conducting an online offer system between a seller and a plurality of buyers. A plurality of offers, including offer price and answers to conditional sale questions are received from prospective buyers participating in the online offer management system for an item for sale are received and stored. The plurality of offers are sorted in a ranking order schema based on an algorithmic model computing the overall net value of the offers based on offer price and weighted values assigned to the conditional questions. The net value of the offers is sorted to determine the current ranking of the offers based on the best to worst overall value. The offers are displayed on the web page associated with the item for sale. A winning offer, regardless of ranking order, is determined by the seller and the associated buyer is notified of the winning offer.

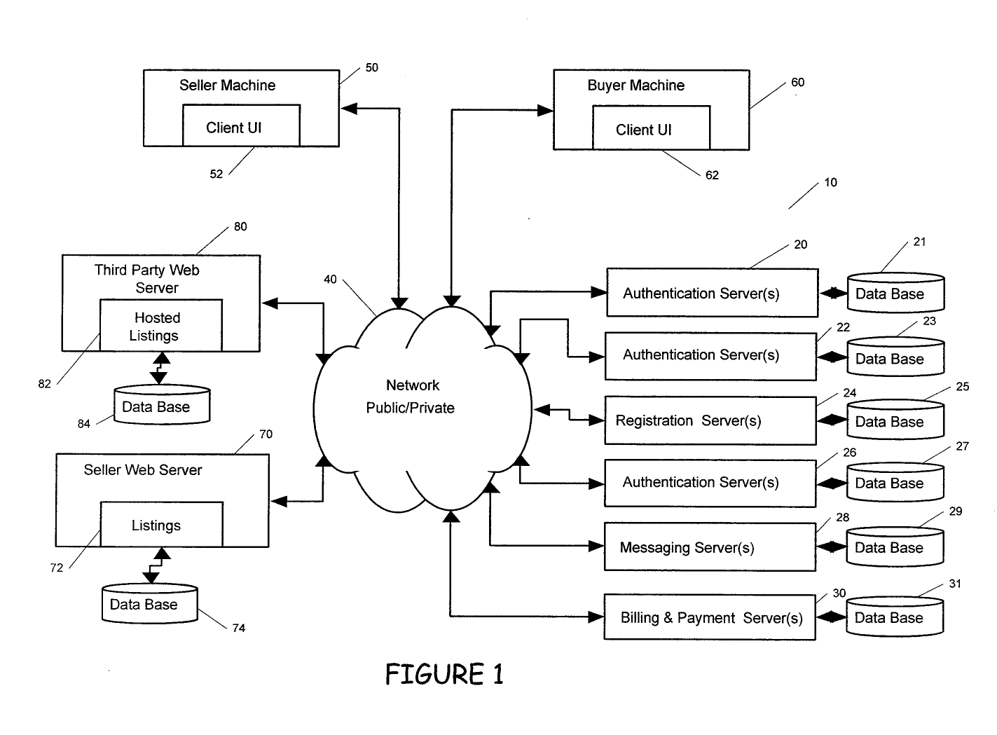

FIG. 1 illustrates a network-based electronic commerce system 10 having a client-server architecture according to an exemplary embodiment of the invention. The system 10 includes several specialized servers provided by an ecommerce service provider. The specialized servers include an authorization server 20, an application server 22, a registration server 24, an administration server 26, a messaging server 28, and a billing and payment server 30. These servers share information and associated databases 21, 23, 25, 27, 29, 31 over a public or private network 40 to manage a transactional process between a seller 50 and a buyer(s) 60. Seller 50 and buyer 60 communicate with the servers over the network 40 via client user interfaces 52, 62, respectively. The servers may be co-located or geographically dispersed over a wide area. Some of the specialized servers 20, 22, 24, 26, 28, 30, 32 may combine some or all of the functions of the other servers. In another aspect, the processes and databases of each of the specialized servers could be combined and operated from a single server and database.

Registered sellers can list items for sale 72 on the seller's web server 70. The list of items for sale by the seller can be stored in database 74. Items for sale can also be listed on a third party web server 80 hosting the listings 82 of items for sale by at least one seller. The hosted listings 82 can be stored in database 84.

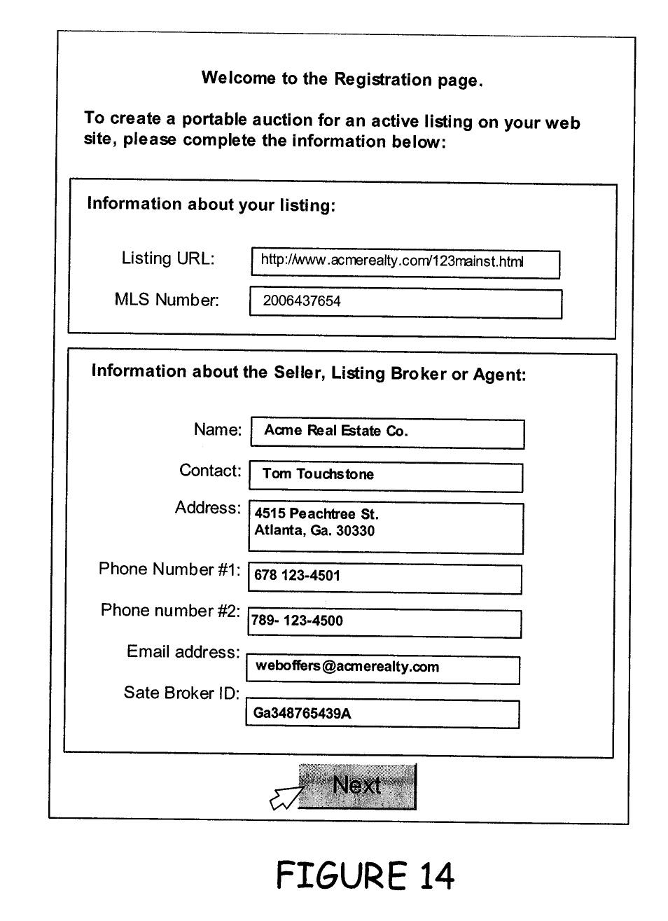

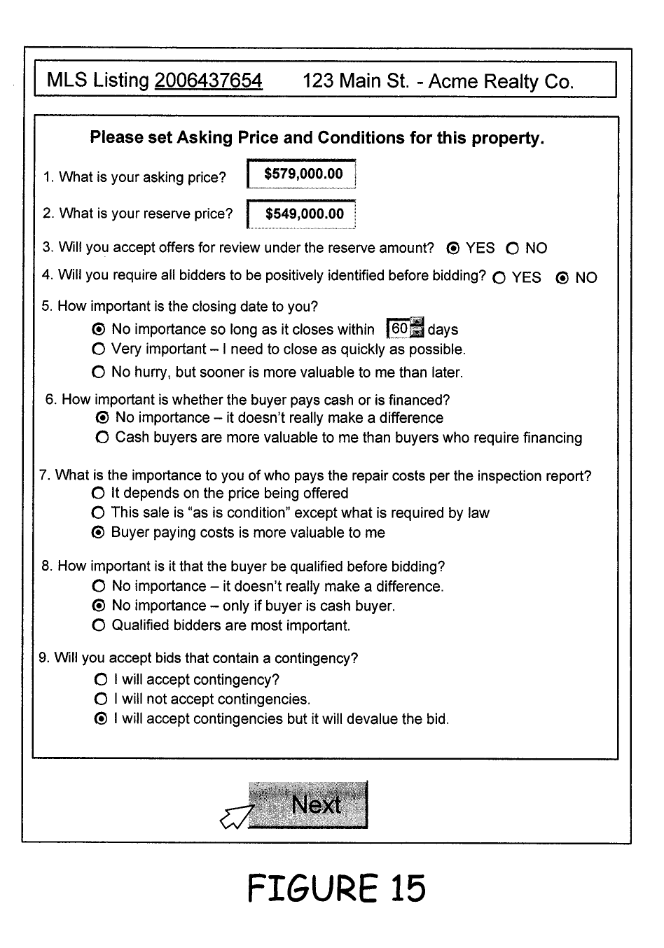

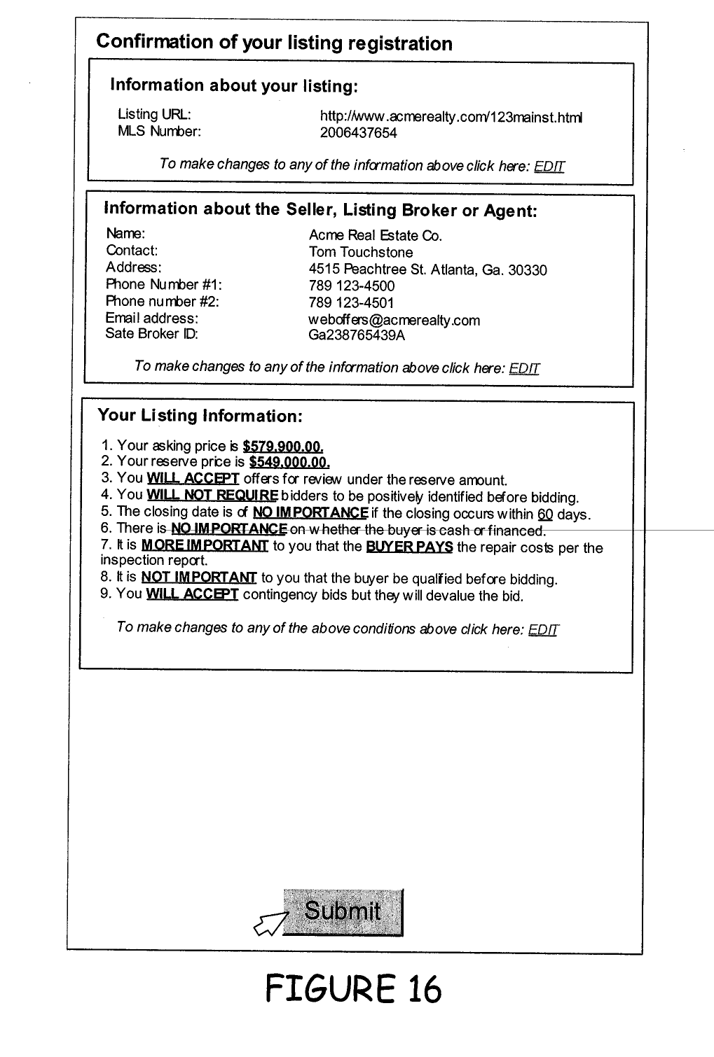

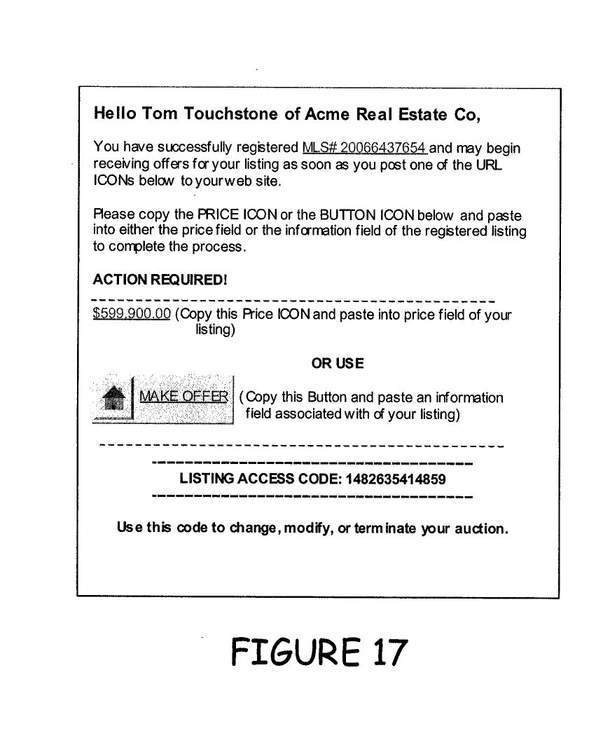

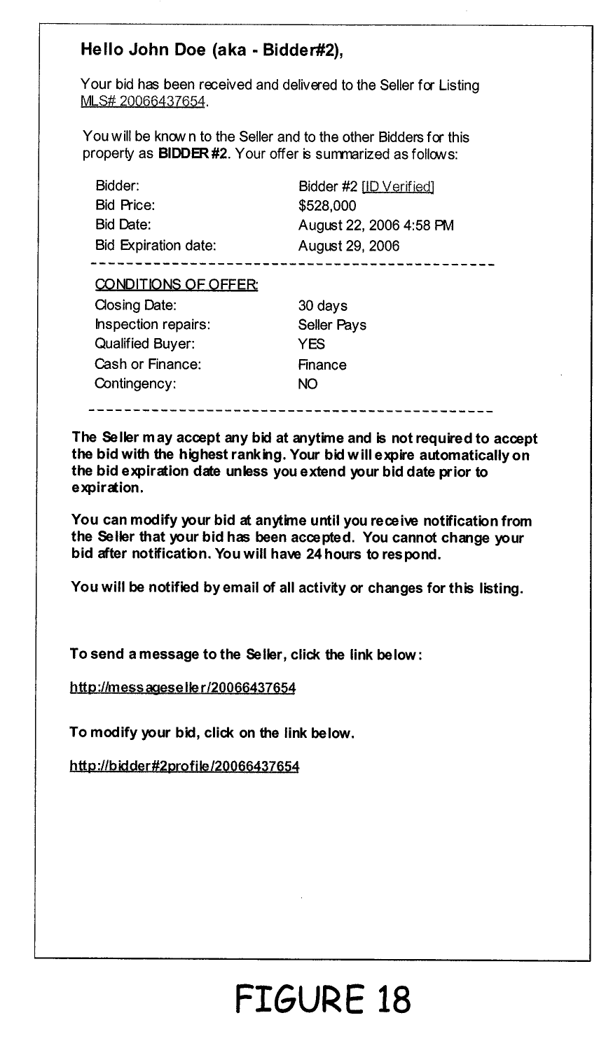

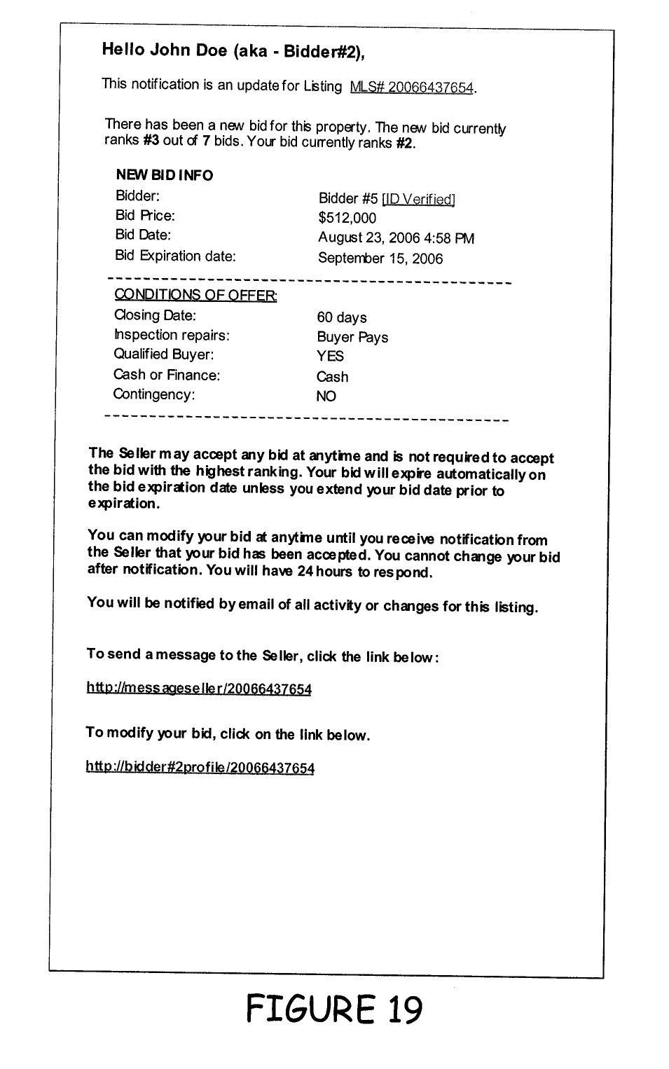

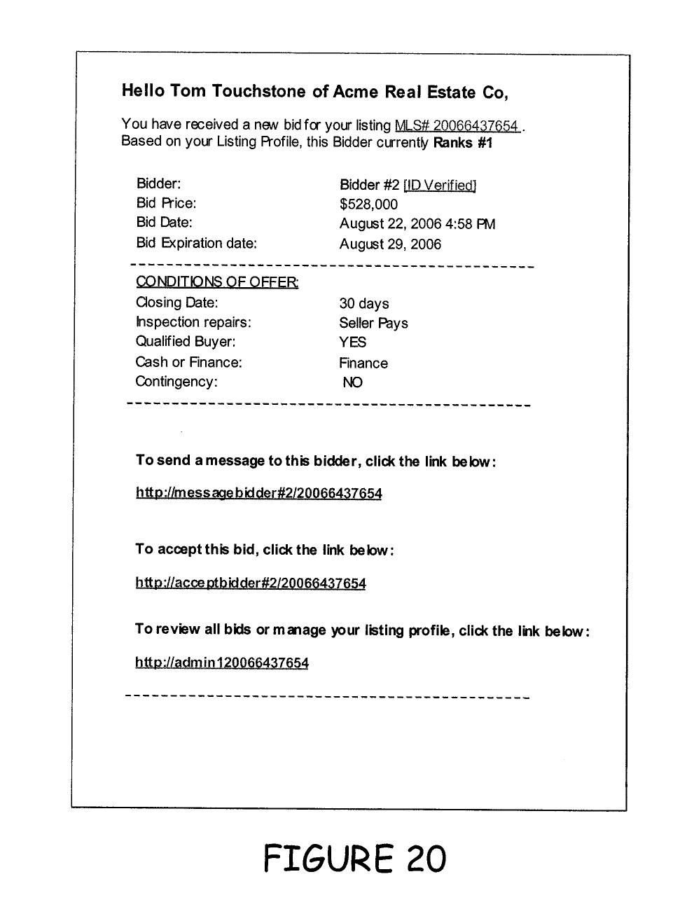

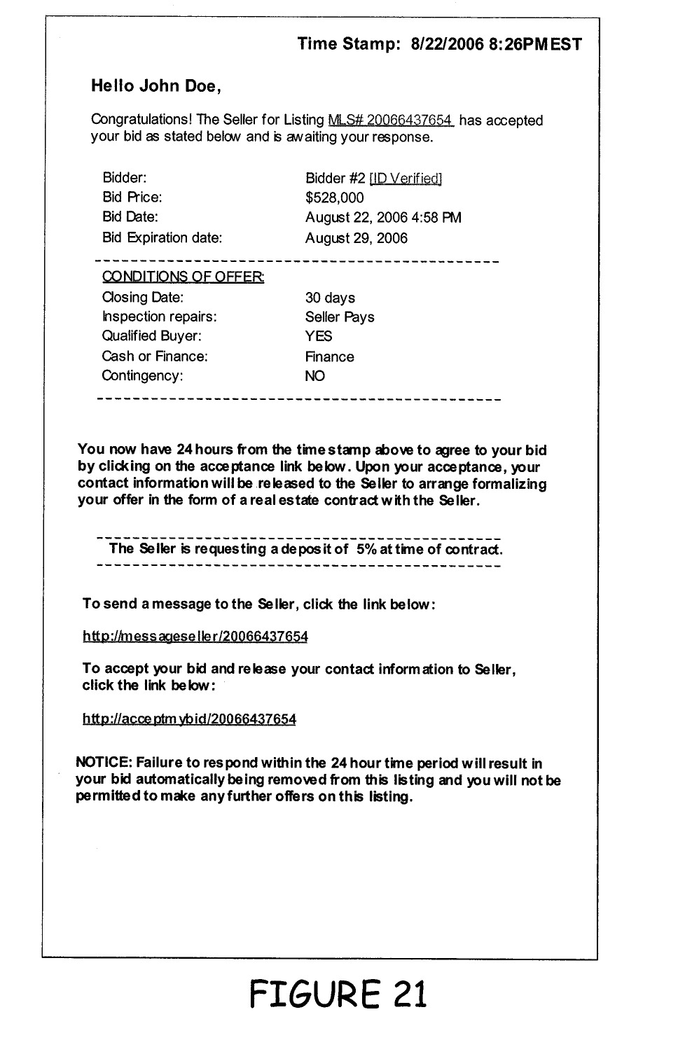

Within the ecommerce system, the registration server 24 is used to present to sellers 50 a means for registering an item for sale to enable the acceptance of offers from prospective buyers 60. The computers associated with both buyers and sellers are clients or client devices in the client-server architecture employed by the invention. In the context of the invention, a seller can include, but is not limited to, an individual seller, a merchant, a vendor, an agent or a sales representative. An item for sale can include, but is not limited to, a product, a service, real property, personal property, intellectual property and any combination of the foregoing. Sellers 50 complete an application on the registration server 24 including seller information and information associated with the asking price, reserve price, and conditional terms of sale, if any, for the item for sale contained on a web site 70 owned or under control of the seller. An example of the seller registration process for a real property listing is depicted in FIGS. 14-16. A unique auction program associated with a URL hyperlink is generated that is associated with the item for sale along with the sale price and conditions established by the seller 50 as registered during the registration process. The unique auction program is also referred to herein as a code segment. More generally, the auction program can be a web widget, i.e., a portable segment of code that can be installed and executed within an HTML-based web page by an end user. The code segment can be embedded within the web page and does not require additional compilation. The unique auction program and the associated URL hyperlink are generated by the registration server 24 based on the information provided by the seller 50 during the registration process and the URL hyperlink is electronically communicated to the seller in a manner such that the seller can copy and paste the URL into a HyperText Markup Language (HTML) compatible field of a web page on web server 70 owned by, or under the control of, the seller. FIG. 17 illustrates an exemplary user interface to effect the transfer of the unique URL into the web page of the seller.

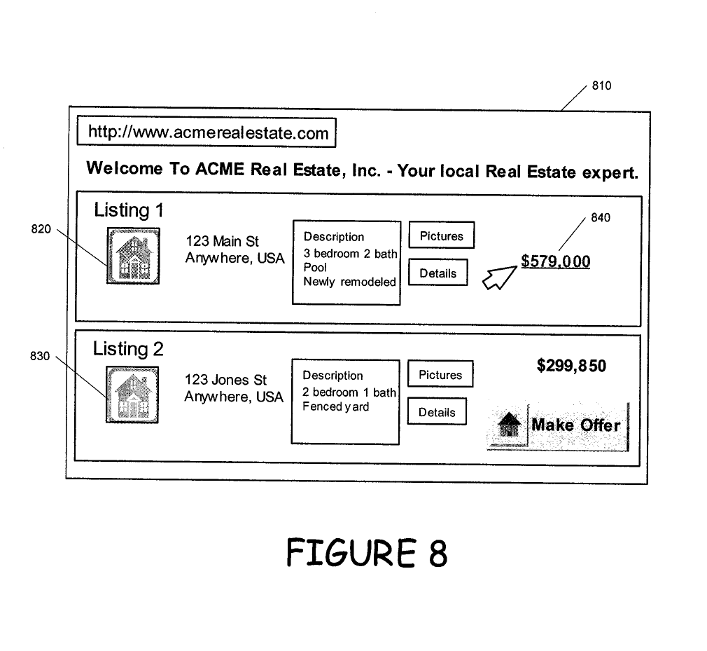

Furthermore, the unique URL hyperlink can be created and embedded into a displayable icon presentation of the link. An example of displayable icons for a real estate listing is depicted in the user interface 810 of FIG. 8 which includes two property listings 820, 830. A price icon 840 is associated with listing number 820. The price icon has been pasted into the web page 810 by the seller 50.

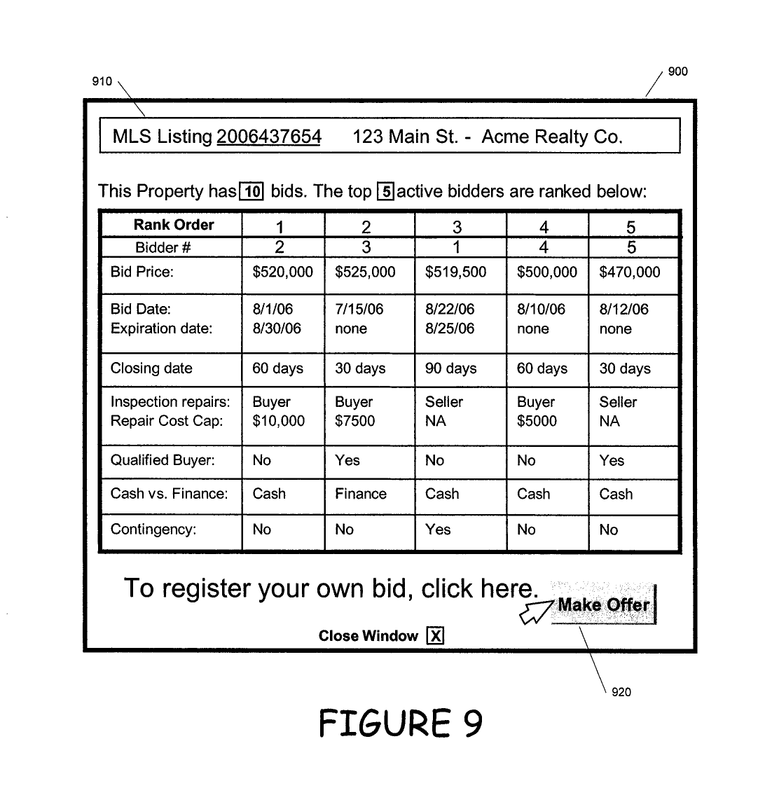

In either case, whether using a URL link or an icon with an embedded URL link, the associated link can display a web page that contains information as to the current bidding activity of the associated item as well as a means for the prospective buyer to register a competing offer. One such exemplary web page is shown in FIG. 9. The web page 900 identifies the property for offer 910, the total number of offer, and information on the top five offers. The web page 900 contains previous offers from other prospective buyers ranked in order of best offer based on the compilation of buyers' offers as compared to the preferred price and conditions as set by the seller. A prospective buyer can enter his own offer by selecting the “Make Offer” button 920.

As further shown in FIG. 9, a method of identification (ID) protection is provided for prospective buyers 60 during the transactional process by issuing offer ID numbers to prospective buyers. Prospective buyers 60 are only known to the seller 50 as Bidder #1, Bidder #2, etc. until such time that the seller has accepted a winning offer, the winning prospective buyer is notified and the winning buyer has agreed to release his or her identity to the seller.

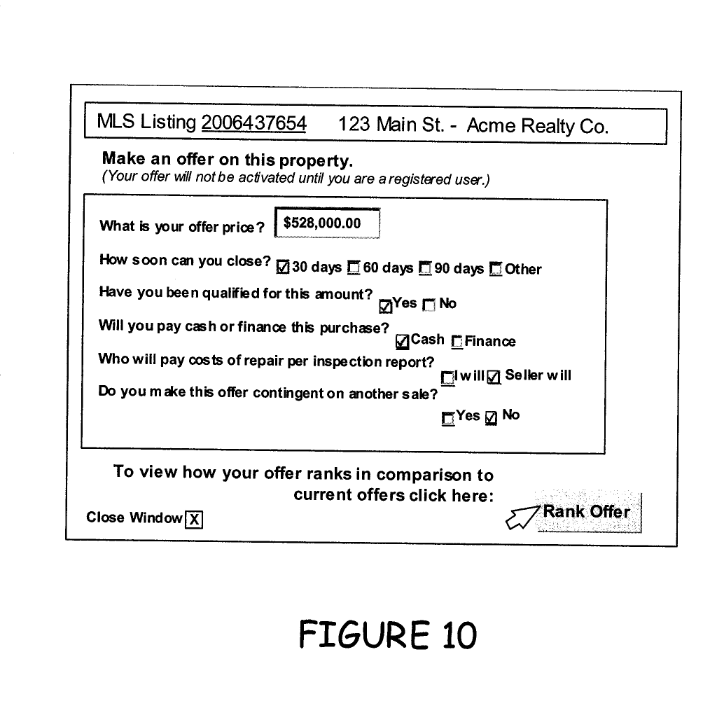

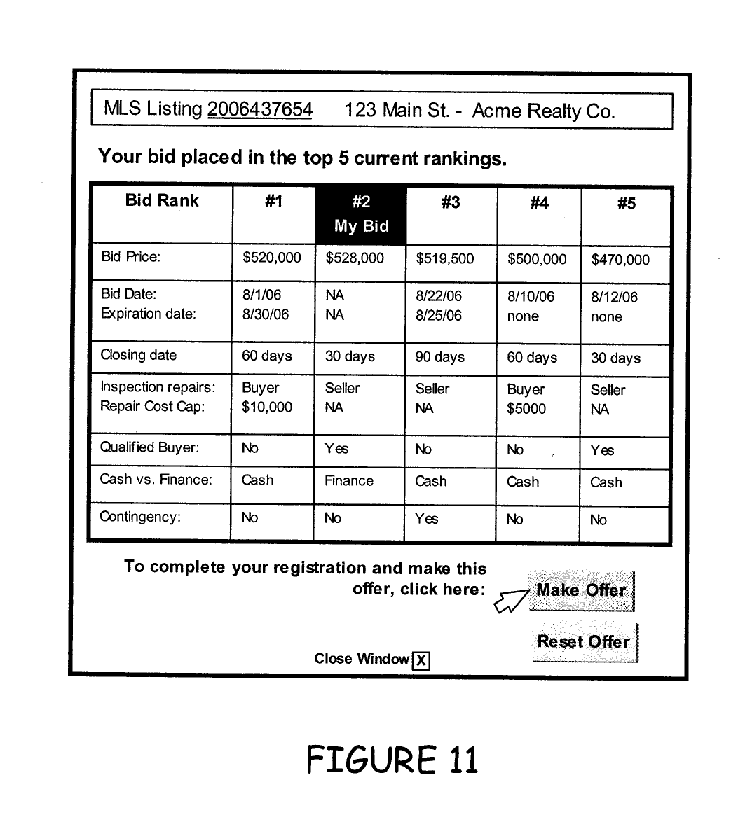

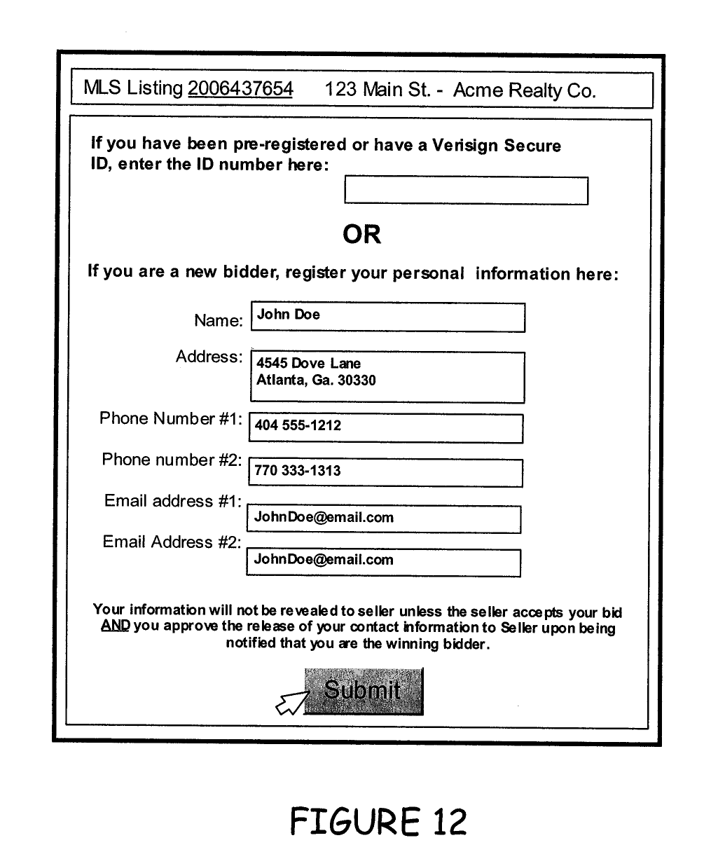

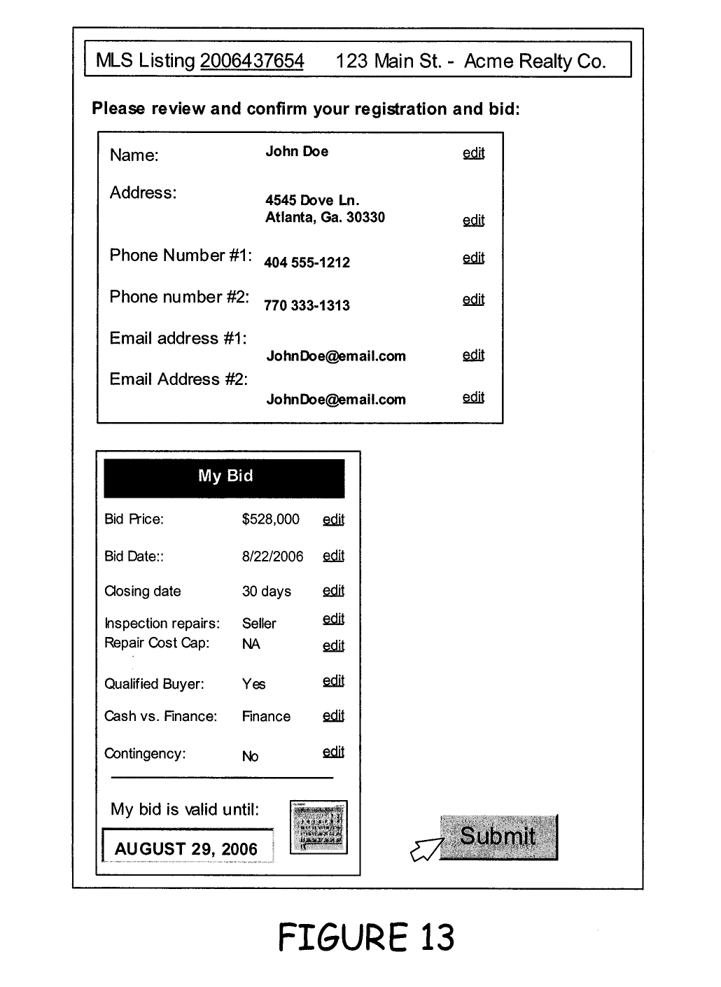

In an exemplary embodiment, the invention provides a method for presenting, as part of the registration process, a number of conditional options that are required to be answered by a prospective buyer 60 during the offer process and that may be selected by the seller 50 and made part of the offer web page presented to prospective buyers 60. The method includes a means for the seller 50 to set absolute conditions regarding an offer from a prospective buyer 60. FIG. 10 illustrates a user interface for enabling a prospective buyer to enter offer information including any contingency information. A further embodiment includes a means for the seller 50 to set non-absolute conditions based on weighted preferences regarding an offer from a prospective buyer 60. A further embodiment includes the means for a seller 50 to set the importance level of certain conditions which will be used to compare and rank offers from prospective buyers 60.

Another embodiment provides a method of managing the communications among the parties to an offer transaction. This embodiment also includes the real-time updating of communications among parties through electronic communications such as email and including in the communications the current ranking of each of the prospective buyers' offers, and embedded links to change, modify, or terminate a buyers' respective offer. This embodiment enables free flowing communications between prospective buyers 60 and seller 50 while at all times protecting the identity of the prospective buyers.

A further embodiment provides a method of broadcasting, through electronic communications to a predefined list of non-participating prospective buyers and buyers' representatives, offer information regarding a pending sale transaction. Offer data can be broadcast via email or other electronic means among a community of interested parties to promote and encourage additional competing offers, thus furthering the establishment of true market value for the product or service offered for sale. In this embodiment a URL link is embedded in the broadcast notification associated with the pending sale item such that the non-participating prospective buyers and buyers' representatives could be linked to a web page for registering a competing offer.

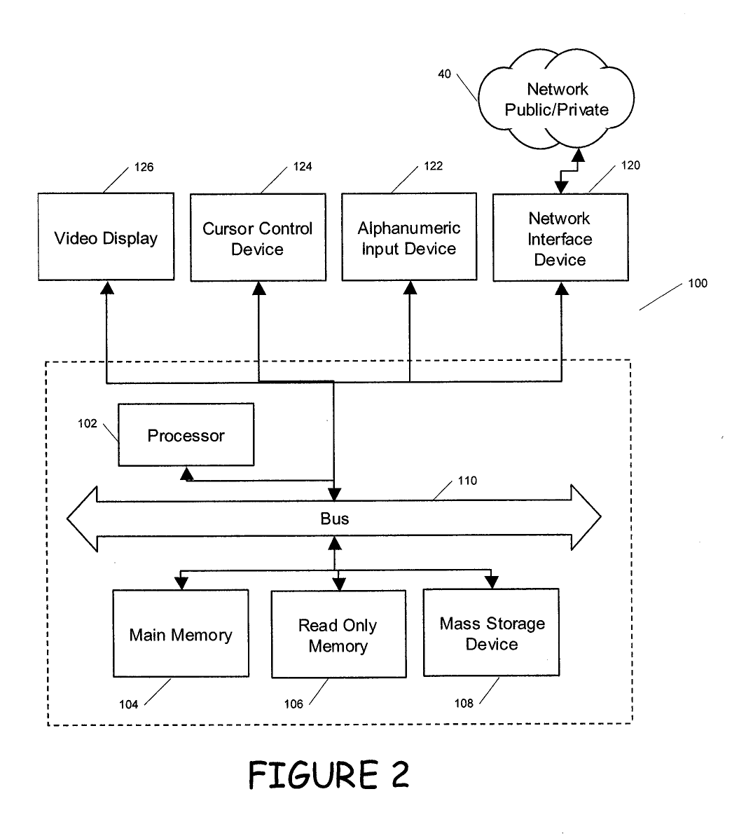

FIG. 2 illustrates a general programmable processing system 100 that can be used in the various embodiments of the invention, e.g., seller machine 50, buyer machine 60. Components of the general processing system 100 include processor 102, main random access memory (RAM) 104, read only memory (ROM) 106, and mass storage device 108. Communications between the processor 102 and RAM 104, ROM 106 and storage device 108 takes place over communications bus 110. Other components of the processing system 100 include video display 126, cursor control device 124, alphanumeric input device 122 and network interface device 120. The network interface device 120 enables communications with other processing devices over private or public network 40.

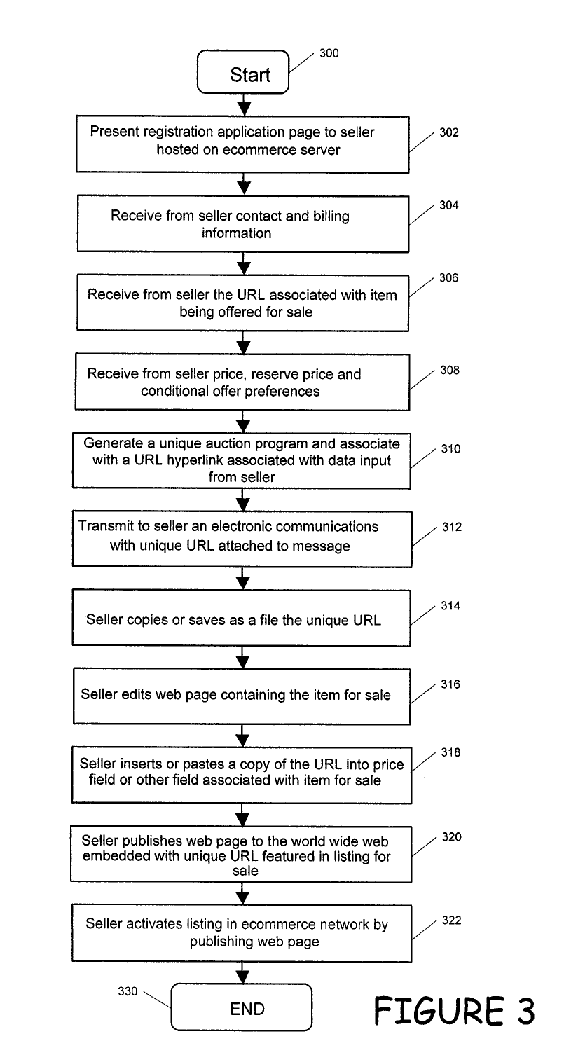

FIG. 3 illustrates the processing logic for generating and publishing a unique URL for an item being sold on a merchant's web site. The process begins in start block 300. The service provider presents an online listing registration application page to the seller or seller's agent that is hosted on an electronic commerce server of the service provider as indicated in logic block 302. A plurality of sale condition options, in addition to price, is presented for selection by the seller on the registration application. At least one completed condition option is received from the seller in response to the options presented. The seller's contact and billing information are received as part of the registration process in logic block 304. The seller also provides a URL that is associated with the item being offered for sale as indicated in logic block 306. The item URL provides a link to item descriptive information on the seller's web site. The seller also provides a price, a reserve price and conditional offer information to the service provider ecommerce server as indicated in logic block 308. The listing registration application information and condition selection information received from the seller are stored and processed by an electronic commerce computer.

The ecommerce server generates an auction program associated with a unique hyperlink that is associated with the seller's registration and item for sale information as indicated in logic block 310. The ecommerce server transmits a communications message electronically by email or other means to the seller or seller's agent that includes the unique hyperlink attached to the message as shown in logic block 312. The seller then copies or saves the unique hyperlink as a file in logic block 314. This can be followed by the seller editing the web page featuring the item for sale on the seller's web site as shown in logic block 316. The seller inserts or pastes a copy of the hyperlink into the price field or another data field associated with the item for sale. This step is indicated in logic block 318. The seller then publishes the web page to the Internet or other computer network with the embedded unique hyperlink featured in the listing for sale in logic block 320. The seller activates the listing in the ecommerce network by publishing the web page as indicated in logic block 322. This part of the process then ends in block 330.

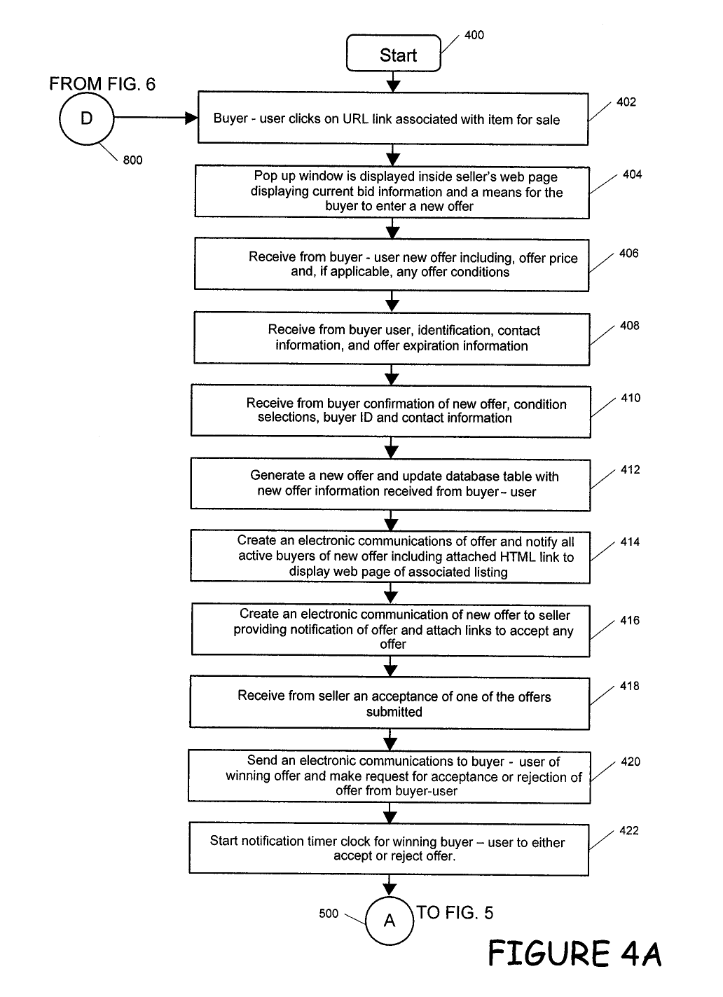

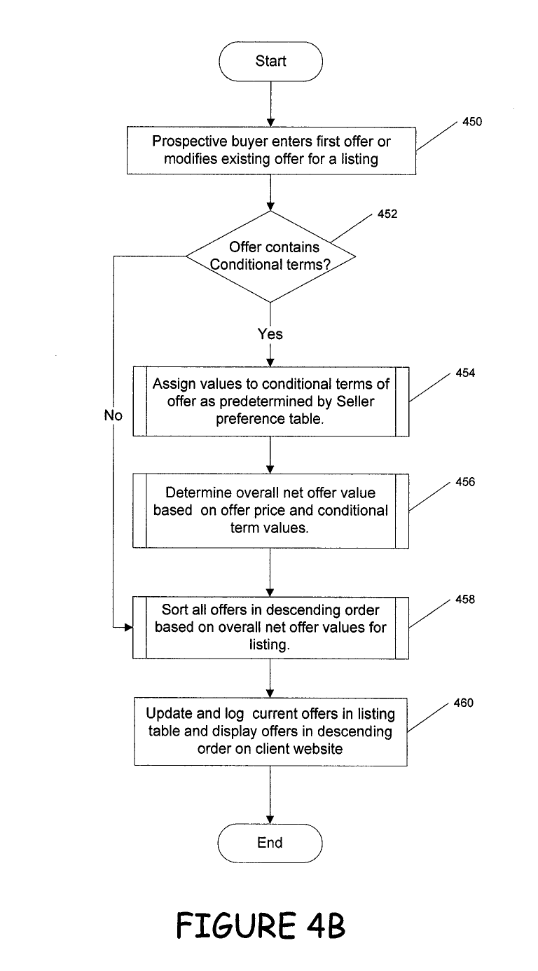

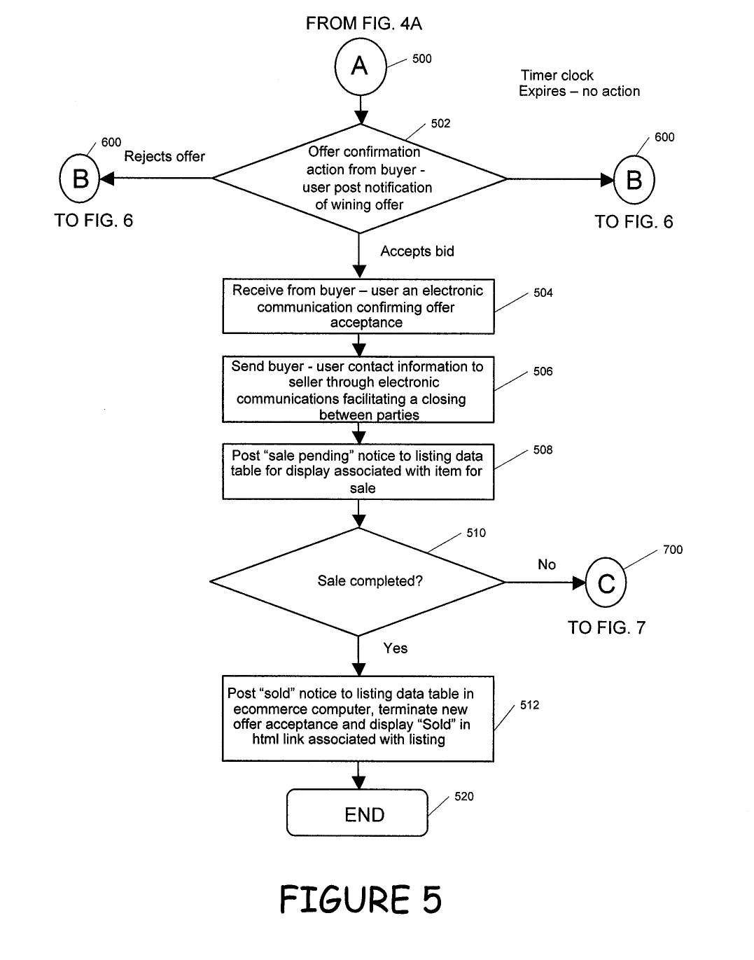

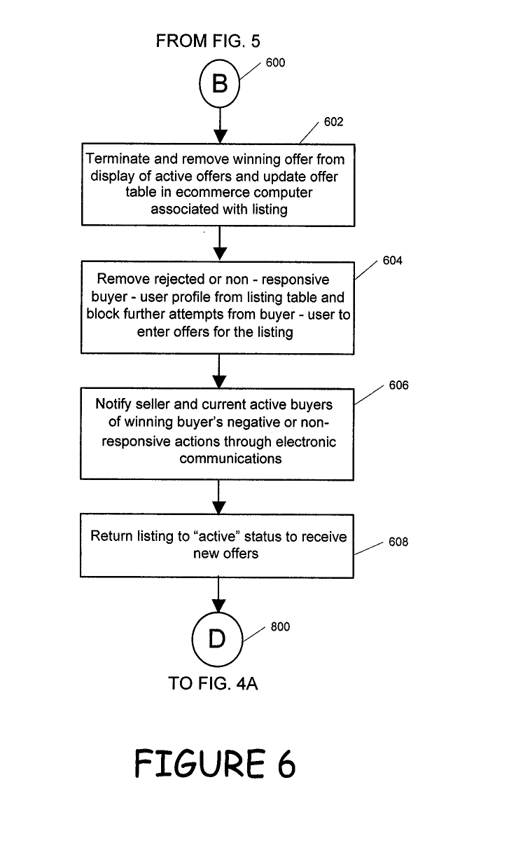

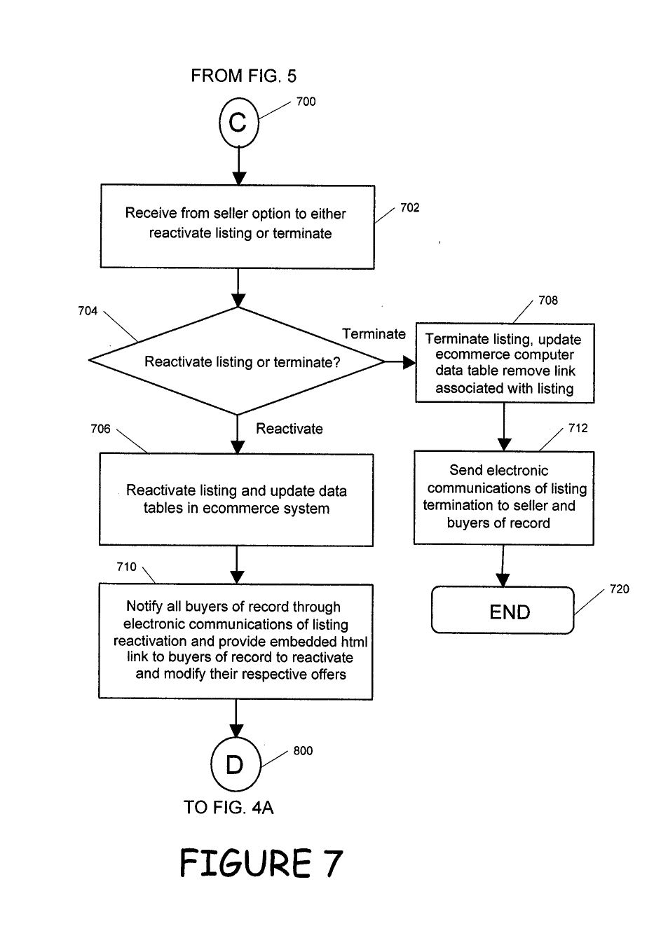

FIG. 4A illustrates exemplary processing logic for offer presentation and acceptance on the merchant (seller) web site that can occur after the seller activates the item listing in the ecommerce network of the server provider by publishing the web page containing the unique hyperlink. Processing begins in block 400. A prospective buyer/user initiates the online sale process by clicking on the unique hyperlink associated with the item for sale as indicated in logic block 402. A buyer clicking on the hyperlink will open an interactive presentation window displaying the current offers made on the associated listing and ranking order of the offers. Buyers may view offers, make a trial offer, place a new offer, or modify an existing offer initiated from this window. This step is indicated in logic block 404. The seller then receives from the prospective buyer/user a new offer including offer price and any offer conditions, if applicable, as shown in logic block 406. The prospective buyer also provides user identification, contact information and offer expiration information as shown in logic block 408. The buyer confirms the new offer, condition selections, buyer ID and contact information in logic block 410.

The ecommerce computer generates a new offer and updates a database table with the new offer information received from the buyer/user as indicated in logic block 412. An electronic communication of the offer is created and all active bidders are notified of the new offer and are provided attached HTML links to display the web page of the associated listing as indicated in logic block 414. An electronic communications of the offer is transmitted to the seller providing notification of the new offer and attaching links to the notification to accept any offer. This step is indicated in logic block 416. If the seller accepts an offer, the seller transmits an acceptance of one of the offers submitted to the ecommerce computer as shown in logic block 418. An electronic communication is sent to the buyer/user submitting the winning offer along with a request that the winning buyer accept or reject the offer as indicated in logic block 420. The winning offer is determined by the seller regardless of a ranking order discussed below. A notification timer clock for the winning buyer/user is started to either accept or reject the offer in logic block 422.

The conditional offer processing logic illustrated in FIG. 4B supplements the processing logic of FIG. 4A. As indicated in logic block 450, the prospective buyer enters a first offer or modifies an existing offer for a listing. This step supplements logic block 404 of FIG. 4A. Following the step of receiving the new offer in logic block 410 of FIG. 4A, a test is made in decision block 452 to determine if the offer contains conditional terms. If the offer contains conditional terms, then logic blocks 454, 456 and 458 are executed. If the offer does not contain conditional terms, then logic block 458 is executed. In logic block 454, the processor assigns values to the conditional terms of the new offer as predetermined by the seller's preference table. In logic block 456, the processor determines an overall net offer value based on the offer price and conditional term values. All offers are then sorted in descending order based on overall net offer values for the listing as shown in logic block 458. Supplementing logic block 416 of FIG. 4A, the processor updates the listing table with the current offers and displays the offers in descending order on the seller's website as indicated in logic block 460.

From logic block 422 (i.e., start notification timer) of FIG. 4A, processing logic continues as shown by connector A 500 in FIG. 5. In decision block 502, if the buyer/user rejects the offer after notification of the winning offer, or if the buyer/user fails to respond before the timer clock expires, then the processing logic continues as illustrated in FIG. 6 (connector B 600). If the buyer/user confirms (i.e., accepts) the offer in decision block 502, an electronic communications is received from the buyer/user as shown in logic block 504. The buyer/user contact information is sent to the seller through electronic communications to facilitate a closing between the parties as indicated in logic block 506. This step is followed in logic block 508 by posting a “sale pending” notice to the listing data table for the display associated with the item for sale.

In decision block 510, a test is made to determine whether or not the sale of the item has been completed. If the sale fails to complete, processing continues in FIG. 7 (connector C 700). If the sale is completed, then a “sold” notice is posted to listing data table in the ecommerce computer. New offer acceptance is terminated and the “sold” is displayed in an HTML link associated with the listing. These steps are shown in logic block 512. Processing then ends in block 520.

FIG. 6 illustrates the processing logic for returning an item listing to an active status after the winning buyer rejects the offer or fails to respond before the timer clock expires. This sequence of the processing logic is entered from the processing flow of FIG. 5 via connector B 600. The winning offer is terminated and removed from the display of active offers in logic block 602. The offer table in the ecommerce computer associated with the listing is also updated. The profile for the buyer/user that has rejected the offer or failed to respond is removed from the listing table and any further attempts from the buyer/user to enter offers for the listing are blocked as indicated in logic block 604. The seller and current active buyers are notified of the winning buyer's negative or non-responsive actions through electronic communications as indicated in logic block 606. The listing is then returned to active status to receive new offers as shown in logic block 608. Processing then returns to the logic of FIG. 4A via logic connector D 800.

FIG. 7 illustrates the processing logic for reactivating or terminating a listing by the seller after the pending sale fails to close with the winning buyer. This sequence of the processing logic is entered from the processing flow of FIG. 5 via connector C 700. Logic block 702 indicates receiving from the seller, an option to either reactivate the listing or to terminate the process. The decision step to reactivate the listing or to terminate is shown in decision block 704. If the seller decides to reactivate the listing, the data tables in the ecommerce system are updated and the listing is reactivated as indicated in logic block 706. This is followed by a notification to all bidders of record through electronic communications of listing reactivation as shown in logic block 710. An embedded HTML link is provided to the buyers of record to reactivate and modify their respective offers. Processing then returns to the logic of FIG. 4A via logic connector D 800.

In decision block 704, if the seller decides to terminate the listing, the ecommerce computer data table is updated and the link associated with the listing is removed as reflected in logic block 708. An electronic communications of the listing termination is then sent to the seller and bidders of record as shown in logic block 712. Processing then ends in termination block 720.

In this description, the term “buyer” is intended to include an actual buyer or prospective buyers of an item for sale. The term “seller” identifies a person or party offering an item for sale by an online sale negotiation process among prospective buyers. The buyer submitting the winning offer can be referred to as the “winning buyer.” The phrase “electronic commerce network” includes, but is not limited to, the Internet. The phrase can also include a private network, such as an intranet or extranet, or any wide area network.

An auction program, as used herein, could include a portable segment of code that can embedded within a web page, thereby adding content to the HTML page. The content can include links and images. The portable code segment can be described alternatively, but without limitation, as a web widget, module, capsule, snippet, or plug-in.

An electronic commerce service provider, as used herein, refers to the entity that facilitates, via an ecommerce computer, the interactive electronic commerce transactions between buyers and sellers through a registration, administration and messaging service. The terms “buyer and “bidders” are also used interchangeably herein. The term “listing” is used herein to refer generically to a product or service offered for sale. As such, “listing” is a broader term than connoted by a real property listing in a real estate application of the invention.

The system and methods of the present invention have been described as computer-implemented processes. It is important to note, however, that those skilled in the art will appreciate that the mechanisms of the present invention are capable of being distributed as a program product in a variety of forms, and that the present invention applies regardless of the particular type of signal bearing media utilized to carry out the distribution. Examples of signal bearing media include, without limitation, recordable-type media such as diskettes or CD ROMs, and transmission type media such as analog or digital communications links.

The corresponding structures, materials, acts, and equivalents of any means plus function elements in any of the claims below are intended to include any structure, material, or acts for performing the function in combination with other claim elements as specifically claimed.

Those skilled in the art will appreciate that many modifications to the exemplary embodiment are possible without departing from the scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed is:

1. A method for facilitating interactive electronic commerce transactions over an electronic commerce network between a seller and a plurality of buyers, comprising the steps of:
receiving from a seller a request to generate an auction program over the electronic commerce network associated with the seller;
generating the auction program associated with the seller by an electronic commerce computer;
generating an URL hyperlink associated with the auction program by the electronic commerce computer; and
forwarding the URL hyperlink to the seller for inclusion into a web page hosted on a website that displays information associated with an item for sale.

2. The method for facilitating interactive electronic commerce transactions of claim 1 further comprising:
entering the URL hyperlink into a web page hosted on a website that displays information associated with the item for sale; and
publishing the web page embedded with the URL hyperlink to make available to the buyers a means to make offers on the item for sale on the electronic commerce network.

3. The method for facilitating interactive electronic commerce transactions of claim 1 further comprising displaying a web page associated with the auction program after receiving a request from a buyer who clicks on the URL hyperlink.

4. The method for facilitating interactive electronic commerce transactions of claim 1 wherein the seller includes an agent or representative of the seller.

5. The method for facilitating interactive electronic commerce transactions of claim 1 wherein an association with the seller includes at least one of a seller's identification and a seller's contact information.

6. The method for facilitating interactive electronic commerce transactions of claim 1 wherein the auction program associated with the seller by an electronic commerce computer includes a condition of sale.

7. The method for facilitating interactive electronic commerce transactions of claim 1 wherein the hyperlink comprises a code segment to display auction information on the web page and to communicate auction information over the electronic commerce network.

8. The method for facilitating interactive electronic commerce transactions of claim 1 wherein the website is hosted by the seller or an independent party.

9. The method for facilitating interactive electronic commerce transactions of claim 1 wherein the URL hyperlink comprises a textual form.

10. The method for facilitating interactive electronic commerce transactions of claim 1 wherein the URL hyperlink comprises an image form.

11. A system for facilitating interactive electronic commerce transactions over an electronic commerce network between a seller and a plurality of buyers, comprising:
a processor for executing a plurality of components for enabling electronic commerce transactions including:
a component for receiving from a seller a request to generate an auction program over the electronic commerce network associated with the seller;
a component for generating the auction program associated with the seller by an electronic commerce computer;
a component for generating an URL hyperlink associated with the auction program by the electronic commerce computer; and
a component for forwarding the URL hyperlink to the seller for inclusion into a web page hosted on a website that displays information associated with an item for sale.

12. The system for facilitating interactive electronic commerce transactions of claim 11 further comprising:
a component for entering the URL hyperlink into a web page hosted on a website that displays information associated with the item for sale; and
a component for publishing the web page embedded with the URL hyperlink to make available to the buyers a means to make offers on the item for sale on the electronic commerce network.

13. The system for facilitating interactive electronic commerce transactions of claim 11 further comprising a component for displaying a web page associated with the auction program after receiving a request from a buyer who clicks on the URL hyperlink.

14. The system for facilitating interactive electronic commerce transactions of claim 11 wherein the auction program associated with the seller by an electronic commerce computer includes a condition of sale.

15. The system for facilitating interactive electronic commerce transactions over an electronic commerce network of claim 11 wherein the hyperlink comprises a code segment to display auction information on the web page and to communicate auction information over the electronic commerce network.

16. The system for facilitating interactive electronic commerce transactions over an electronic commerce network of claim 11 wherein the hyperlink comprises a textual form.

17. The system for facilitating interactive electronic commerce transactions over an electronic commerce network of claim 11 wherein the hyperlink comprises an image form.

18. A computer readable medium containing instructions for controlling a computer system to facilitate interactive electronic commerce transactions over an electronic commerce network between a seller and a plurality of buyers, by:
receiving from a seller a request to generate an auction program over the electronic commerce network associated with the seller;
generating the auction program associated with the seller by an electronic commerce computer;
generating an URL hyperlink associated with the auction program by the electronic commerce computer; and
forwarding the URL hyperlink to the seller for inclusion into a web page hosted on a website that displays information associated with an item for sale.

19. The computer readable medium for controlling a computer system to facilitate interactive electronic commerce transactions of claim 18, by:
entering the URL hyperlink into a web page hosted on a website that displays information associated with the item for sale; and
publishing the web page embedded with the URL hyperlink to make available to the buyers a means to make offers on the item for sale on the electronic commerce network.

20. The computer readable medium for controlling a computer system to facilitate interactive electronic commerce transactions of claim 18 by displaying a web page associated with the auction program after receiving a request from a buyer who clicks on the URL hyperlink.
